(19) United States
(12) Patent Application Publication
(10) Pub. No.: US 2022/0167481 A1
(43) Pub. Date: May 26, 2022

(54) LIGHT SOURCE STATUS DETECTION

(71) Applicant: Google LLC, Mountain View, CA (US)

(72) Inventors: Dongeek Shin, Mountain View, CA (US); Shwetak Patel, Mountain View, CA (US); Anupam Pathak, San Carlos, CA (US)

(21) Appl. No.: 17/521,063

(22) Filed: Nov. 8, 2021

Related U.S. Application Data
(60) Provisional application No. 63/117,259, filed on Nov. 23, 2020.

(51) Int. Cl. H05B 47/11; H05B 47/19; H05B 47/115; G08B 21/24

(52) U.S. Cl. CPC H05B 47/11; H05B 47/19; G01J 1/4204; G08B 21/24; H05B 47/115

(57) ABSTRACT

Systems and techniques are provided for light source status detection. Ambient light values generated by an ambient light sensor of a device in an environment over a period of time may be received. A first light source model for the device may be generated using a first subset of the ambient light values. A second light source model for the device may be generated using a second subset of the ambient light values. A current ambient light value generated by the ambient light sensor of the device may be received. The first light source model or the second light source model may be selected based on a time at which the current ambient light value was generated. Whether the current ambient light value indicates that a local artificial light source is on may be determined using the current ambient light value and selected light source model.

### BACKGROUND

Local artificial light sources that are left on in unoccupied environments may result in wasted energy and increased energy bills. Local artificial light sources that have, or are inserted into fixtures or connected to power sources that have, electronics for communication with computing devices may be able to inform occupants when the local artificial light sources are left on after the occupants have left the environment with the local artificial light sources through notifications sent occupants phones or other portable devices. The status of local artificial light sources that do not have, and are not connected to power sources that have, such electronics may be more difficult to determine, as the local artificial light sources may not be able to directly inform an occupant who has left the environment that the local artificial light source has been left on.

### BRIEF SUMMARY

According to an embodiment of the disclosed subject matter, a computing device may receive ambient light values generated by an ambient light sensor of a device in an environment over a first period of time may be received from the device at a computing device. The computing device may generate a first light source model for the device using a first subset of the ambient light values. The computing device may generate a second light source model for the device using a second subset of the ambient light values. The computing device may receive from the device, a current ambient light value generated by the ambient light sensor of the device. The computing device may select one of either the first light source model or the second light source model based on a time at which the current ambient light value was generated by the ambient light sensor. The computing device may determine, using the current ambient light value and selected one of the first light source model and the second light source model, whether the current ambient light value indicates that a local artificial light source is on.

The computing device may generate a first light source model for the device using a first subset of the ambient light values comprising ambient light values by fitting a 2-gaussian model to the first subset of the ambient light values using a 2-cluster prior wherein the first subset of ambient light values is divided into a background light source cluster and a local artificial light source cluster by the fitting and centering the background light source cluster at the origin of the first light source model.

The computing device may fit a 2-gaussian model to the first subset of the ambient light values using a 2-cluster prior wherein the first subset of ambient light values is divided into a background light source cluster and a local artificial light source cluster by using Baum-Welch type optimization.

The computing device may determine, using the current ambient light value and selected one of the first light source model and the second light source model, whether the current ambient light value indicates that a local artificial light source is on by determining a likelihood-ratio based on the current ambient light value and the selected one of the first light source model and the second light source model and determining that a local artificial light source is on when the likelihood-ratio greater than a threshold value for the selected one of the first light source model and the second light source model or determining that a local artificial light source is not on when the likelihood-ratio is less than the threshold value for the selected one of the first light source model and the second light source model.

A notification may be sent to a device associated with an occupant when the current ambient light value indicates that a local artificial light source is on.

The current ambient light value generated by the ambient light sensor of the device may be received at the computing device after a determination by any computing device in or associated with the environment that an occupant of the environment has exited the environment. The determination that the occupant of the environment has exited the environment may be a triggering event for generating and sending the current ambient light value to the computing device.

The first subset of the ambient light values may include ambient light values generated over a same second time period on each day of the first time period. The second subset of the ambient light values may include ambient light values generated over a same third time period on each day of the first time period. The first subset of the ambient light values and the second subset of the ambient light values are disjoint.

The computing device may select one of either the first light source model or the second light source model based on a time at which the current ambient light value was generated by the ambient light sensor by comparing the time of day at which the current ambient light value was generated to the times of day at which the ambient light values in the first subset of ambient light values were generated and the times of day at which the ambient light values in the second subset of ambient light values were generated.

The first time period comprises a training period for light source models for the device at a current location of the device in the environment

According to an embodiment of the disclosed subject matter, a means for receiving, on a computing device from a device in an environment, ambient light values generated by an ambient light sensor of the device over a first period of time, a means for generating, by the computing device, a first light source model for the device using a first subset of the ambient light values, a means for generating, by the computing device, a second light source model for the device using a second subset of the ambient light values, a means for receiving, on the computing device from the device, a current ambient light value generated by the ambient light sensor of the device, a means for selecting, by the computing device, one of either the first light source model or the second light source model based on a time at which the current ambient light value was generated by the ambient light sensor, a means for determining, by the computing device, using the current ambient light value and selected one of the first light source model and the second light source model, whether the current ambient light value indicates that a local artificial light source is on, a means for fitting a 2-gaussian model to the first subset of the ambient light values using a 2-cluster prior wherein the first subset of ambient light values is divided into a background light source cluster and a local artificial light source cluster by the fitting, a means for centering the background light source cluster at the origin of the first light source model, a means for determining a likelihood-ratio based on the current ambient light value and the selected one of the first light source model and the second light source model, a means for determining that a local artificial light source is on when the likelihood-ratio greater than a threshold value for the selected one of the first light source model and the second light source model, a means for determining that a local artificial light source is not on when the likelihood-ratio is less than the threshold value for the selected one of the first light source model and the second light source model, a means for sending a notification to a device associated with an occupant when the current ambient light value indicates that a local artificial light source is on, and a means for comparing the time of day at which the current ambient light value was generated to the times of day at which the ambient light values in the first subset of ambient light values were generated and the times of day at which the ambient light values in the second subset of ambient light values were generated, are included.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1A shows an example system and arrangement suitable for light source status detection according to an implementation of the disclosed subject matter.

FIG. 1B shows an example system and arrangement suitable for light source status detection according to an implementation of the disclosed subject matter.

FIG. 2A shows an example arrangement suitable for light source status detection according to an implementation of the disclosed subject matter.

FIG. 2B shows an example arrangement suitable for light source status detection according to an implementation of the disclosed subject matter.

FIG. 2C shows an example arrangement suitable for light source status detection according to an implementation of the disclosed subject matter.

FIG. 3A shows an example system and arrangement suitable for light source status detection according to an implementation of the disclosed subject matter.

FIG. 3B shows an example system and arrangement suitable for light source status detection according to an implementation of the disclosed subject matter.

FIG. 4A shows an example visualization suitable for light source status detection according to an implementation of the disclosed subject matter.

FIG. 4B shows an example visualization suitable for light source status detection according to an implementation of the disclosed subject matter.

FIG. 4C shows an example visualization suitable for light source status detection according to an implementation of the disclosed subject matter.

FIG. 5 shows an example process suitable for light source status detection according to an implementation of the disclosed subject matter.

FIG. 6 shows a computing device according to an embodiment of the disclosed subject matter.

FIG. 7 shows a system according to an embodiment of the disclosed subject matter.

FIG. 8 shows a system according to an embodiment of the disclosed subject matter.

FIG. 9 shows a computer according to an embodiment of the disclosed subject matter.

FIG. 10 shows a network configuration according to an embodiment of the disclosed subject matter.

### DETAILED DESCRIPTION

According to embodiments disclosed herein, light source status detection may allow for the detection of local artificial light sources in an environment that have been left turned on and the notification of an occupant of the status of local artificial light sources in the environment. A device with an ambient light sensor may be positioned in part of an environment that includes local artificial light sources. Models specific to a device and the device's immediate surroundings in the environment may be trained to distinguish background light sources and local artificial light sources near the device using the light detected by the ambient light sensor of the device across time. After the models are trained, measurements of ambient light levels by the ambient light sensor of the device may be input to the models to determine if a local artificial light source has been left on near the device. The device may notify an occupant of the environment who has recently exited the environment when a local artificial light source near the device is determined to have been left on.

An environment may include a number of devices. The environment may be, for example, a home, office, apartment, or other structure, outdoor space, or combination of indoor and outdoor spaces Devices in the environment may include, for example, lights, sensors including passive infrared sensors used for motion detection, light sensors, cameras, microphones, entryway sensors, light switches, as well as mobile device scanners that may use Bluetooth, WiFi, RFID, or other wireless devices as sensors to detect the presence of devices such as phones, tablets, laptops, or fobs, security devices, locks, A/V devices such as TVs, receivers, and speakers, devices for HVAC systems such as thermostats, motorized devices such as blinds, and other such controllable device. The devices may also include general computing devices, such as, for example, phones, tablets, laptops, and desktops. The devices within the environment may include computing hardware, including processors, volatile and non-volatile storage, and communications hardware for wired and wireless network communication, including WiFi, Bluetooth, and any other form of wired or wireless communication. The computing hardware in the various devices in the environment may differ. The devices in the environment may be connected to the same network, which may be any suitable combination of wired and wireless networks, and may involve mesh networking, hub-and-spoke networking, or any other suitable form of network communications.

A device in the environment may include an ambient light sensor. The ambient light sensor may be any suitable sensor for measuring ambient light levels in the vicinity of the sensor and generating an ambient light value that indicates the ambient light level. The ambient light sensor may, for example, detect and output separate values based on measuring red, green, and blue light ambient levels. The device may be positioned in location in the environment that receives light from local artificial light sources. The local artificial light sources may be any light sources that are powered, including lighting of any type, such as incandescent, halogen, florescent and LED lighting in any form. The local artificial light sources may also include other electricity-based sources of artificial light, such as televisions and monitor, and non-electricity-based sources of artificial light, such as, for example, candles and fires. The location in the environment may also receive light from background light sources. Background light sources may include natural light sources, such as sunlight and moonlight, and non-local artificial light sources, which may be artificial light sources that are not located within the environment and not controlled by any occupant of the environment, such as street lights on the street outside of a house.

Models specific to a device and the device's immediate surroundings in the environment may be trained to distinguish background light sources and local artificial light sources near the device using the ambient light levels measured by the ambient light sensor of the device across time. A device may be left in the same position in an environment for a period of time that may serve as a training period for light source models for the device. The ambient light levels measured by the ambient light sensor over the training period may be stored as ambient light values. The ambient light values may be stored on the device that has the ambient light sensor, on another device within the environment to which the device is connected through a local network connection, or on a remote computing device that may be part of a cloud computing system remote from the environment and to which the device is connected through, for example, the internet.

The ambient levels detected over the training period and stored may be used to train light source models for the device with the ambient light sensor. Any suitable number of light source models may be trained for the device, with each trained light source model being trained on the stored ambient light values from any suitable subset of ambient light values measured within the training period. For example, twenty-four separate light source models may be trained for a device, with each light source model being trained on a subset of stored ambient light values from the same one-hour period of each day of the training period. This may result in the device having a separate light source model for each hour of the day. Light source models may also be trained based on detecting that occupants have exited either the location of the device or the environment, for example, using other devices both in the environment and belonging to an occupant. When the occupant is determined to have exited the location of the device or the environment, a light source model may be trained using ambient light values for some time period around the time at which the occupant was determined to have exited, across every day of the training period. For example, if ambient light values have been stored during a seven day training period, and on one of the days an occupant was detected as exiting the environment at 9:00 am, a light source model may be trained using the stored ambient levels for 8:30 am to 9:30 am from all seven days of the training period.

Light source models may be trained in any suitable manner using the ambient light values generated by the ambient light sensor measuring ambient light levels and stored during the training period. For example, a light source model may be trained using cluster anchoring to obtain a two-cluster manifold for the background light sources and the local artificial light sources. The clustering may be performed on the stored ambient light values, which may be, for example, tuples that each include separate values for red, green, and blue ambient light levels for each measurement of the ambient light level taken using the ambient light sensor of the device. The subset of ambient light values from the training period may be used to train a light source model by using cluster anchoring procedure to center the baseline cluster to the origin. This may be done by fitting a parametric model to the subset of ambient light values being used to train the light source model. A 2-cluster prior may be used to fit a 2-gaussian model to the subset of ambient light values being used to train the light source model. The 2-cluster prior may include one cluster for the background light sources and one cluster for the local artificial light sources. The fitting of the 2-cluster prior to the 2-gaussian model may be accomplished, for example, using Baum-Welch type optimization. Training the 2-gaussian model may be done according to:

$$\begin{matrix} \text{?} {\prod }_{k = 1}^{N} ( {α}_{0} \cdot {f}_{0} ( {x}_{k} ; {μ}_{0} , {\sum }_{0} ) + {α}_{1} \cdot {f}_{1} ( {x}_{k} ; {μ}_{1} , {\sum }_{1} ) ) & ( 1 ) \\ and & \\ f ( x = [ {x}_{k} , {x}_{G} , {x}_{B} ] : μ , \sum ) = \frac{1}{\sqrt{{( 2 π )}^{k} \vert \sum \vert}} exp \{ - \frac{1}{2} {( x - μ )}^{T} {\sum }^{- 1} ( x - μ ) \} \\ \text{?} \text{indicates text missing or illegible when filed} & ( 2 )\end{matrix}$$

After the 2-cluster prior is used to fit to the 2-gaussian model to the ambient light values being used to train the light source model, the mean of the cluster for the background light sources may be used to anchor-correct by centering the cluster of the background light sources at the origin of the cluster model according to:

y←y−μ₀

μ₀←0

μ₁←μ₁−μ₀ (3)

The light source model may be trained using a subset that includes all of the ambient light values from the time period across each day within the training period that the light source model is modelling. For example, if ambient light values were stored over seven days, a light source model that models a one-hour period from 6:00 am to 7:00 am may be trained using the ambient light values generated from measurements of ambient light levels from 6:00 am to 7:00 am across each of the seven days, resulting in the subset of ambient light values used to train the light source model including seven one-hour long blocks of ambient light values.

The light source models for a device may be trained using any suitable computing device. For example, the device with the ambient light sensor may have the computational resources needed to train light source models locally, and may do so using the ambient light values from the training period which may also be stored locally on the device, or may be stored remotely. If the device itself does not have the computational resources to train the light source models, the light source models for the device may be trained on another device within the environment that does have sufficient computational resources, or may be trained on a remote computing device, including a computing device that may be part of a cloud computing system. The trained light source models may be stored on any suitable device, including the device with the ambient light sensor whose values the light source models were trained with, another device in the environment with the device, or a remote computing device, such as a computing device that is part of a cloud computing system.

After the training period has ended and the light source models for a device have been trained, ambient light values from the ambient light sensor of the device may be input to the light source models to determine whether a local artificial light source has been left on. A current ambient light value from the ambient light sensor of a device may be input to the appropriate light source model for that device, for example, based on the time the ambient light value is measured, at any suitable time. For example, a current ambient light value may be input to a light source model for a device based on a triggering event. The triggering event may be, for example when it has been determined that an occupant has exited either location of device or the environment. The determination of an occupant exiting may be made in any suitable manner, using any suitable data from any suitable devices in the environment and devices carried or worn by the occupant, such as phones and wearable devices. The appropriate light source model may be determined and selected based on, for, example, the current time. For example, if an occupant is detected exiting the environment at 9:04 am, an ambient light value from an ambient light sensor of a device may be input to a light source model that was trained using ambient light values from the device that were measured between 9:00 am and 10:00 am during the training period.

The light source model may use the input current ambient light value to determine if a local artificial light source has been left on in the vicinity of the device with the ambient light sensor. A likelihood-ratio test may be used with the ambient light value and the light source model to determine whether the ambient light value indicates that a local artificial light source has been left on according to:

$$\begin{matrix}λ = log ( {α}_{0} \cdot {f}_{0} ( y ; 0 , {\sum }_{0} ) ) - log ( {α}_{1} \cdot {f}_{1} ( y ; {μ}_{1} , \sum ) ) \\ = log ( {α}_{0} / {α}_{1} ) + log ( {f}_{0} ( y ; 0 , {\sum }_{0} ) ) - log ( {f}_{1} ( y ; {μ}_{1} , {\sum }_{1} ) ) \\ {>}^{?} T\end{matrix} \qquad ( 4 )$$

The likelihood-ratio determined using the likelihood-ratio test with the ambient light value and the light source model may be subject to a threshold which may be used to generate a binary decision of whether the ambient light value indicates that a local artificial light source has been left on or whether the ambient light value only indicates background light sources. For example, if the likelihood-ratio is above a threshold value, this may indicate that an artificial light source has been left on. If the likelihood-ratio is not above the threshold value, this may indicate that an artificial light source has not been left on.

In some implementations, ambient light values from the ambient light sensor of a device may be input to light source models at suitable intervals. For example, the current ambient light value from an ambient light sensor may be input to the appropriate light source model at any suitable interval, such as once per minute.

The output of the light source models be used in any suitable manner. For example, if the ambient light value was measured based on detecting that an occupant had exited the location of the device or the environment, and the output of the light source model to which the ambient light value is input indicates that an artificial light source has been left on, a notification may be sent to a device associated with the occupant who was detected exiting. The notification may, for example, be sent from the computing device which runs the light source model, or any other suitable computing device, including other computing devices within the environment and computing devices that are part of a cloud computing system. The notification may be sent, for example, to a phone or wearable device that is associated with the occupant who has been detected exiting. The notification may indicate that an artificial light source has been left on, and may further indicate the location of the device in the environment with the ambient light sensor that measured the ambient light value used to determine that the artificial light source was left on.

If the ambient light value is measured and input to a light source model at any suitable intervals, the output from the light source model may be used to, for example, detect changes in a pattern in the use of an artificial light source. For example, if the light source model determines that an artificial light source has been left on at a time when the artificial light source is normally not on, it may be determined, for example, by any suitable computing device with data regarding the pattern of the usage of the artificial light source, that there has been a deviation from the pattern of the usage of the artificial light source. This may indicate, for example, that there is an intruder or other unknown occupant in the environment, and a notification may be sent to any suitable device associated with any suitable person, including occupants of the environment and security personnel. If the light source model determines that an artificial light source is not on at a time when the artificial light source is normally on, it may be determined, for example, by any suitable computing device with data regarding the pattern of the usage of the artificial light source, that there has been a deviation from the pattern of the usage of the artificial light source. This may indicate, for example, that an occupant is ill or injured, and notification may be sent to any suitable device associated with, for example, a family member, friend, or other emergency contact of the occupant, or to emergency personnel.

If the ambient light value is measured and input to a light source model at an interval, the output from the light source model may be used to, for example, correct presence decisions about occupants made using other data, such as GPS and geofencing data. For example, computing devices within the environment, or computing devices in a cloud computing system, may make determinations about whether occupants of the environment are present in or absent from the environment based on GPS data from devices associated with the occupants and geofences associated with the environment. Whether artificial light sources are determined to be on or off and a particular time may be compared with presence and absence determinations made at that time to determine if they agree. For example, if no artificial light sources are determined to be on at a particular time based on the output of light source models, but the presence and absence determinations made using GPS and geofence data indicate that the occupants are present in the environment, the output of the light source models may be used to correct the presence and absence determinations.

Any number of devices in an environment may have ambient light sensors, and every device with an ambient light sensor may have any number of light source models Different devise may have different numbers of light source models, and the time periods covered by a light source model may different across different devices. For example, an environment may include three different devise with ambient light sensors. Each device may have, for example, 24 light source models, each light source model covering a time period of one hour, or, for example, one of the devices may have 24 light source models covering one hour time periods, one of the devices may have 12 light source models covering two hour time periods, and one of the devices may have 8 light source models covering three hour time periods. Different light source models may be used for different time periods to adjust for the differing light levels from background light sources, such as the sun, moon, and streetlights, during different times of day.

When a light source model determines that an artificial light source has been left on near a device, the ambient light value may be used to determine the identity of the artificial light source that has been left on. For example, different artificial light sources may emit light at different lux levels. Any suitable computing device may use the lux level as determined through the ambient light value measured by the ambient light sensor to identify the artificial light source that has been left on. The artificial light source may be identified using, for example, a database calibrated to the local artificial light sources near a device by a user who may, for example, turn each individual artificial light source on separately and input and identity of the light source to a database that may be stored on a computing device in the environment or a computing device that is part of a cloud computing system. The determination of the identify of an artificial light source that has been left on may also be made using, for example, known lux levels for different sources of artificial light.

Devices that are moved may have new light source models trained. For example, a device with an ambient light sensor that is moved from one room of an environment to a new room may re-enter the training period to have new light source models trained using the artificial light sources and background light sources in the new room.

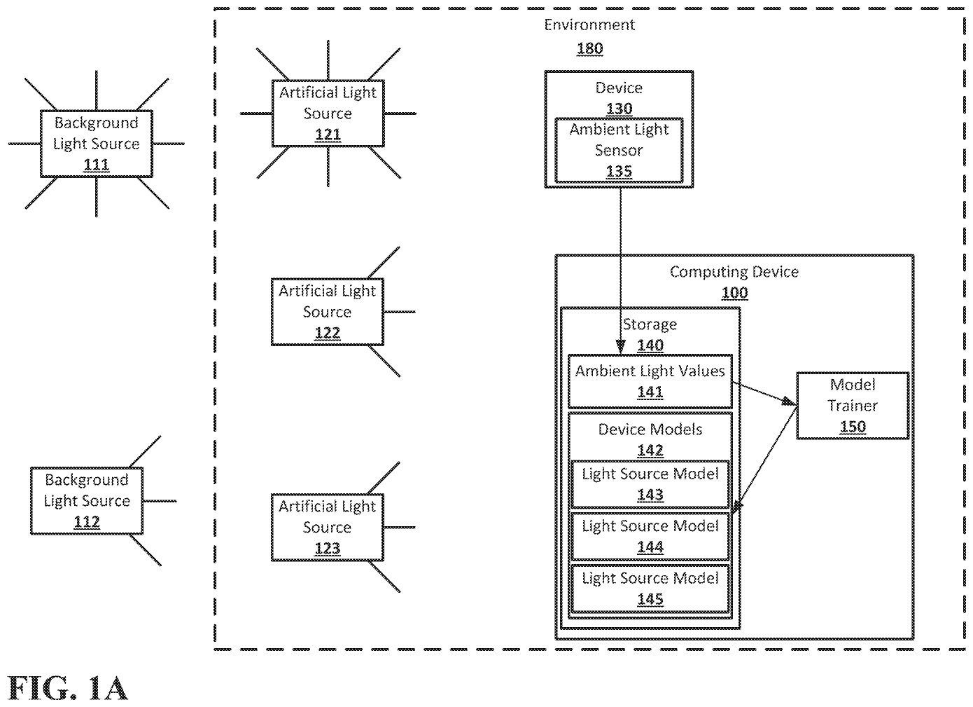

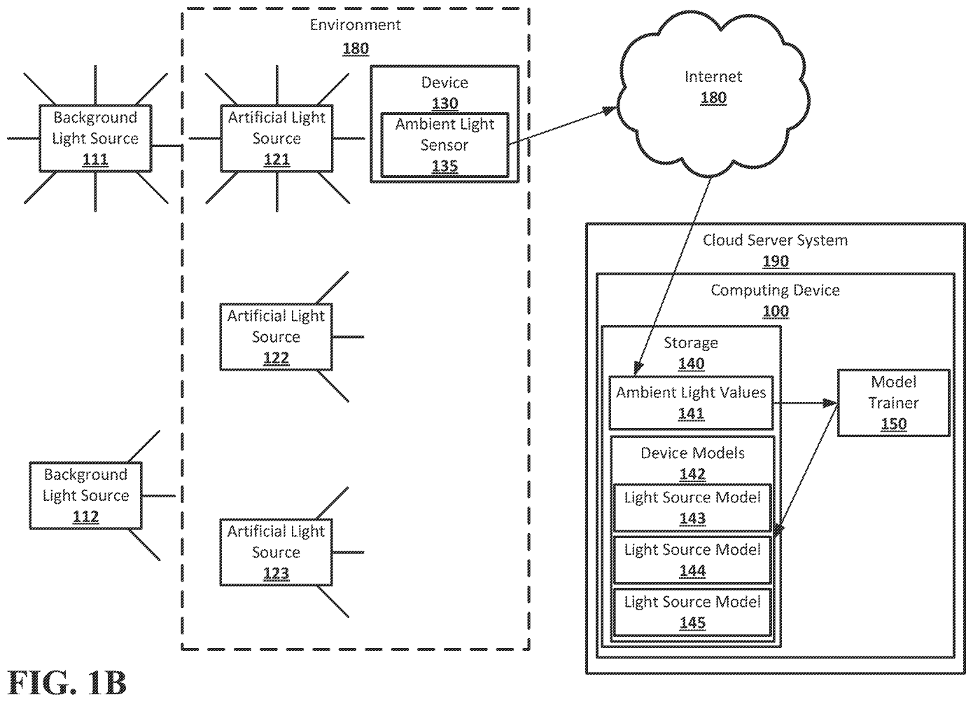

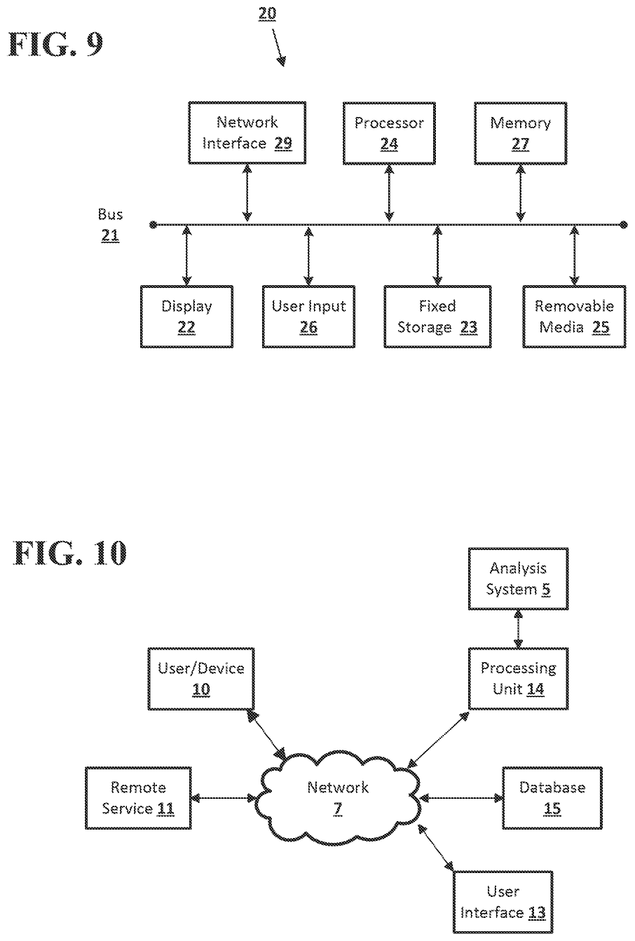

FIG. 1A shows an example system and arrangement suitable for light source status detection according to an implementation of the disclosed subject matter. An environment 180 may include a device 130, a computing device 100, and artificial light sources 121, 122, and 123. The environment 180 may be any suitable environment or structure, such as, for example, a house, office, apartment, or other building, or area with any suitable combination of indoor and outdoor spaces. The device 130 may be any suitable device that may be located in the environment 180 that may include ambient light sensor 135, and may be, for example, a sensor devices, camera device, speaker device, voice-controlled device, or other A/V device. The computing device 100 may be any suitable device, such as, for example, a computer 20 as described in FIG. 9, for implementing a model trainer 150 and a storage 140. The computing device 100 may be a single computing device, or may include multiple connected computing devices, and may be, for example, a laptop, a desktop, an individual server, a server farm, or a distributed server system, or may be a virtual computing device or system. The computing device 100 may be part of a computing system and network infrastructure, or may be otherwise connected to the computing system and network infrastructure. The computing device 100 may, for example, be any suitable device located within the environment 180 that may have sufficient computational resources to implement the model trainer 150. The computing device 100 may, for example, be part of the device 130, or may be separate from the device 130 and may be connected to the device 130 through any suitable form of wired or wireless communication, including through any local or wide area network connection.

The artificial light sources 121, 122, and 123 may be any suitable sources of artificial light that may be local to the device 130 within the environment 180. For example, the artificial light sources 121, 122, and 123 may be incandescent, halogen, florescent and LED lighting in any form, including bulbs, TVs, monitors, or any other devices that use electricity to generate and emit light. The artificial light sources 121, 122, and 123 may be located near enough to the device 130 that the ambient light sensor 135 may be able to detect light emitted from the artificial light sources 121, 122, and 123. For example, the device 130 and the artificial light sources 121, 122, and 123 may be located in the same room of the environment 180.

Background light sources 111 and 112 may be any suitable sources of background light that may be detected by the ambient light sensor 135. For example, the background light sources 111 and 112 may include the sun, the moon reflecting sunlight, street lights outside of the environment 180, and any other lighting source that may be outside of the environment 180 and may not be controllable by occupants of the environment 180.

Ambient light values generated by measuring the ambient light level by the ambient light sensor 135 over a training period may be stored as ambient light values 141 in the storage 140 of the computing device 100. The ambient light level measured by the ambient light sensor 135 at any given time may depend on which of the artificial light sources 121, 122, and 123 and background light sources 111 and 112 are on, or active, at the time of the measurement, and their output levels. The ambient light values 141 may be stored in any suitable format. For example, the ambient light values 141 may be stored as tuples of red, green, and blue ambient light values measured by the ambient light sensor 135. The training period may be any suitable amount of time, such as, for example, three days.

The ambient light values 141 generated during the training period may be used to train light source models for the device 130. The model trainer 150 may train light source models, such as light source models 143, 144, and 145, using the ambient light values 141. Each of the light source models 143, 144, and 145 may cover a different time period across the days of the training period, and may be trained using a different subset of the ambient light values 141. The subsets of the ambient light values 141 used to train different models may be disjoint, for example, with each subset covering the same hours across each day of the training period, with none of the subsets including ambient light values from the same hours as any other subset. For example, the light source model 143 may be trained the using ambient values 141 that were measured between 12:00 am and 8:00 am on each of the three days of the training period, the light source model 144 may be trained the using ambient values 141 that were measured between 8:00 am and 4:00 pm on each of the three days of the training period, and the light source model 145 may be trained the using ambient values 141 that were measured between 8:00 pm to 12:00 am on each of the three days of the training period. The light source models 143, 144, and 145 may be trained by the model trainer 150 using cluster anchoring to obtain a two-cluster manifold for the background light sources 111 and 112 and the artificial light sources 121, 122, and 123.

The model trainer 150 may use a cluster anchoring procedure to center the baseline cluster from input ambient light values to the origin after fitting a parametric model to the ambient light values being used to train the light source model. For example, to train the light source model 143, the model trainer 150 may use 2-cluster prior may be used to fit a 2-gaussian model to the ambient light values 141 that were measured between 12:00 am and 8:00 am on each of the three days of the training period. The 2-cluster prior may include one cluster for the background light sources 111 and 112 and one cluster for the artificial light sources 121, 122, and 123. The 2-cluster prior may be used to the 2-gaussian model to the ambient light values 141 that were measured between 12:00 am and 8:00 am on each of the three days of the training period by, for example, using Baum-Welch type optimization. After the 2-cluster prior has been used fit to the 2-gaussian model to the ambient light values 141 that were measured between 12:00 am and 8:00 am on each of the three days of the training period, the mean of the cluster for the background light sources 111 and 112 may be used to anchor-correct by centering the cluster of the background light sources 111 and 112 at the origin of the cluster model. The resulting model generated by the model trainer 150 may be stored as the light source model 143. The light source models 144 and 145 may be similarly trained and generated by the model trainer 150 using the ambient light values 141 that were measured between 8:00 am and 4:00 pm on each of the three days of the training period and the ambient values 141 that were measured between 4:00 pm and 12:00 am on each of the three days of the training period, respectively.

The trained light source models 143, 144, and 145 may be stored as part of device models 142 in the storage 140. The device models 142 may include any light source models trained for the device 130 based on ambient light values measured by the ambient light sensor 135, such as the ambient light values 141.

FIG. 1B shows an example system and arrangement suitable for light source status detection according to an implementation of the disclosed subject matter. In some implementations, the computing device 100 may be component of a cloud sever system 190. The cloud server system 100 may be any suitable system for cloud computing, such as, for example, any number of computers 20 as described in FIG. 9. The cloud server system 100 may be, for example, cloud computing system including a server system that provides cloud computing services using any suitable computing devices connected in any suitable manner distributed over any area. The cloud computing device 100 may be a component of the cloud server system 190. The ambient light values 141 measured by the ambient light sensor 135 may be transmitted to the cloud server system 190 through, for example, the internet 180, and stored in the storage 140 of the computing device 100. The model trainer 150 may train the light source models that are stored as the device models 142, for example, the light source models 143, 144, and 145, on the cloud server system 190.

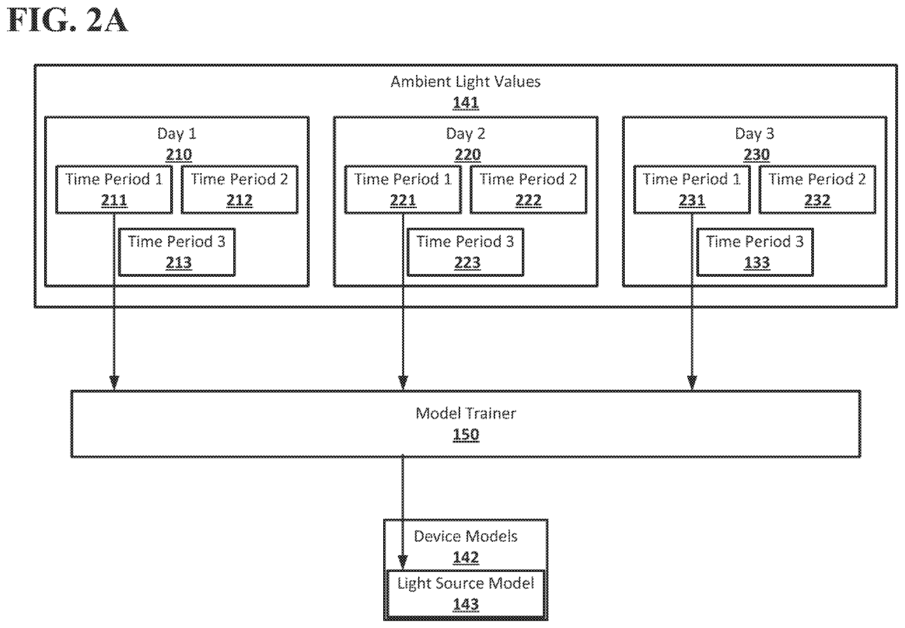

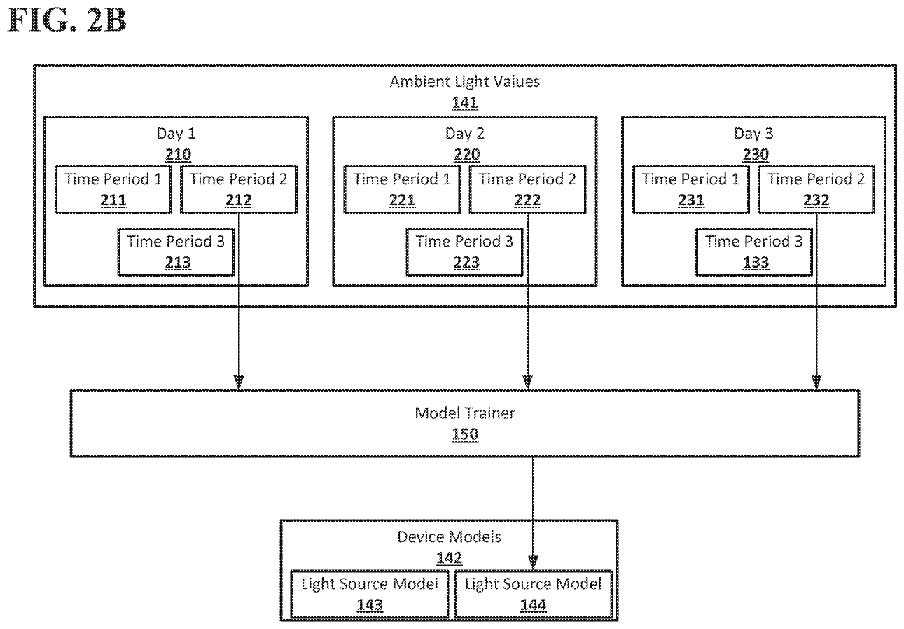

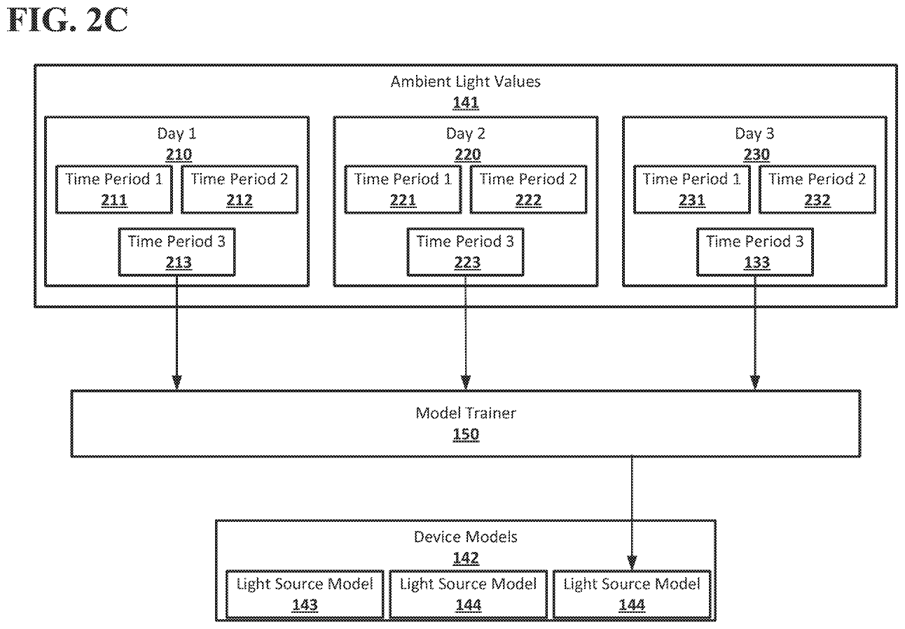

FIG. 2A shows an example arrangement suitable for light source status detection according to an implementation of the disclosed subject matter. The model trainer 150 may train a light source model using ambient light values that were measured during the same time period across the days of the training period. For example, the ambient light values 141 may include ambient light values measured by the ambient light sensor 135 over a training period of three days, each of which maybe divided into three time periods. The ambient light values 141 measured on day 1 210 may be divided into time period 1 211, time period 2 212, and time period 3 213. The ambient light values 141 measured on day 2 220 may be divided into time period 1 221, time period 2 222, and time period 3 223. The ambient light values 141 measured on day 3 230 may be divided into time period 1 231, time period 2 232, and time period 3 233. Time period 1 211 may include, for example, ambient light values measured between 12:00 am and 8:00 am on the first day of the training period, time period 1 221 may include, for example, ambient light values measured between 12:00 am and 8:00 am on the second day of the training period, and time period 1 231 may include, for example, ambient light values measured between 12:00 am and 8:00 am on the third day of the training period. Time period 2 212 may include, for example, ambient light values measured between 8:00 am and 4:00 pm on the first day of the training period, time period 2 222 may include, for example, ambient light values measured between 8:00 am and 4:00 pm on the second day of the training period, and time period 2 232 may include, for example, ambient light values measured between 8:00 am and 4:00 pm on the third day of the training period. Time period 3 213 may include, for example, ambient light values measured between 4:00 pm and 12:00 am on the first day of the training period, time period 3 223 may include, for example, ambient light values measured between 4:00 pm and 12:00 am on the second day of the training period, and time period 3 233 may include, for example, ambient light values measured between 4:00 pm and 12:00 am on the third day of the training period.

The light source model 143 may be trained by the model trainer 150 using the ambient light values 141 from the time period 1 211 of day 1 210, the time period 1 221 of day 2 220, and the time period 1 231 of day 3 230. The light source model 143 may thus be based on dividing ambient light values measured by the ambient light sensor 135 from between 12:00 am and 8:00 am across the three days of the training period into two clusters, one for ambient light values that were generated when the only light that reaches the ambient light sensor 135 is from the background light sources 111 and 112, and one for ambient light values that were generated when the ambient light sensor 135 receives light from any of the artificial light sources 121, 122, and 123 in addition to any light received from the background light sources 111 and 112.

FIG. 2B shows an example arrangement suitable for light source status detection according to an implementation of the disclosed subject matter. The light source model 144 may be trained by the model trainer 150 using the ambient light values 141 from the time period 2 212 of day 1 210, the time period 2 222 of day 2 220, and the time period 2 232 of day 3 230. The light source model 144 may thus be based on dividing ambient light values generated by the ambient light sensor 135 from between 8:00 am and 4:00 pm across the three days of the training period into two clusters, one for ambient light values that were generated when the only light that reaches the ambient light sensor 135 is from the background light sources 111 and 112, and one for ambient light values that were generated when the ambient light sensor 135 receives light from any of the artificial light sources 121, 122, and 123 in addition to any light received from the background light sources 111 and 112.

FIG. 2C shows an example arrangement suitable for light source status detection according to an implementation of the disclosed subject matter. The light source model 145 may be trained by the model trainer 150 using the ambient light values 141 from the time period 3 213 of day 1 210, the time period 3 223 of day 2 220, and the time period 3 233 of day 3 230. The light source model 143 may thus be based on dividing ambient light values measured by the ambient light sensor 135 from between 4:00 pm and 12:00 am across the three days of the training period into two clusters, one for ambient light values that were generated when the only light that reaches the ambient light sensor 135 is from the background light sources 111 and 112, and one for ambient light values that were generated when the ambient light sensor 135 receives light from any of the artificial light sources 121, 122, and 123 in addition to any light received from the background light sources 111 and 112.

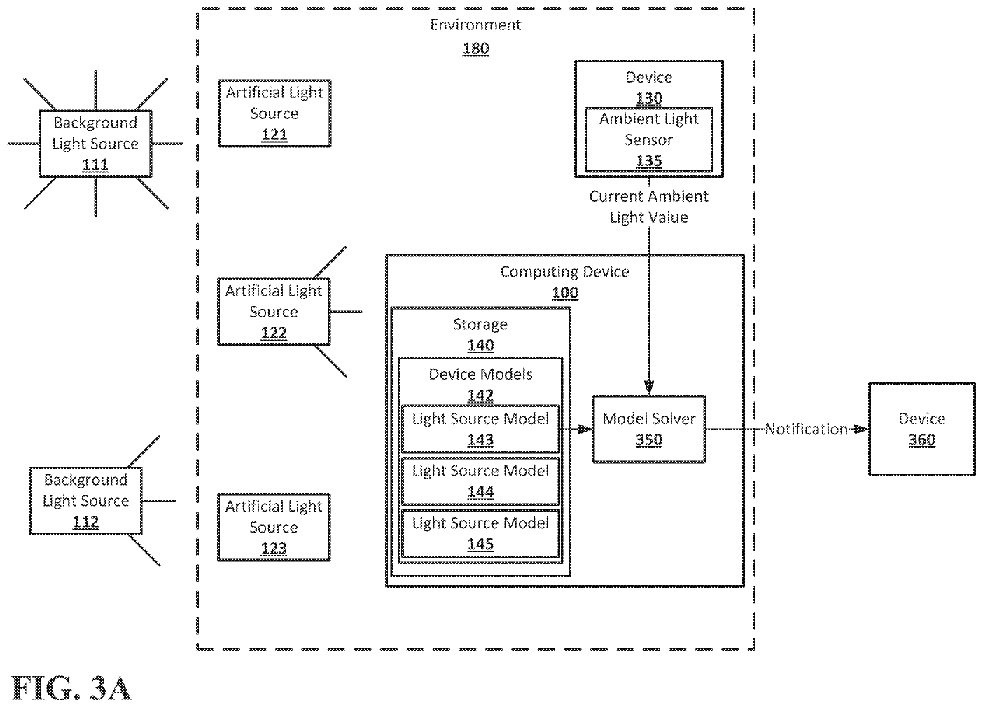

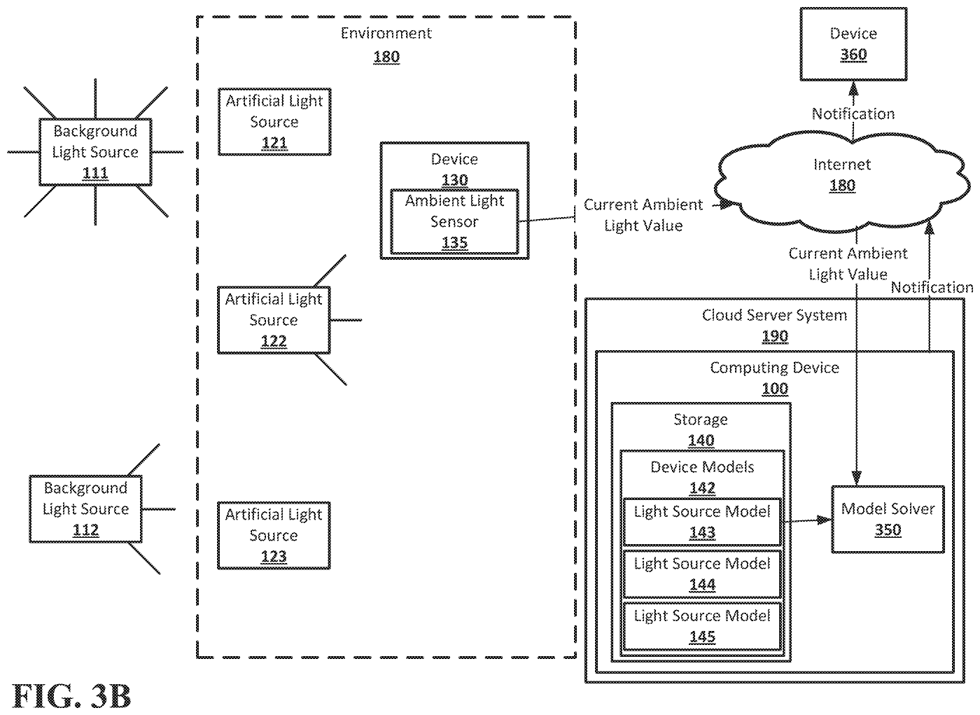

FIG. 3A shows an example system and arrangement suitable for light source status detection according to an implementation of the disclosed subject matter. After the training period is over and the light source models 143, 144, and 145 have been trained for the device 130, ambient light values generated by the ambient light sensor 135 measuring ambient light levels at the location of the device 130 may be used to determine whether one of the artificial light sources 121, 122, and 123 has been left on. For example, the ambient light sensor 135 may measure the current ambient light level at the location of the device 130 in the environment 180 to generate a current ambient light value. The ambient light level measured may be based on, for example, light received at the ambient light sensor 135 from the background light sources 111 and 112, and the artificial light source 122, which may be on. The artificial light sources 121 and 123 may be off. The current ambient light value, as generating by the ambient light sensor 135 measuring the current ambient light level, may be transmitted to the computing device 100. The ambient light sensor 135 may measure the ambient light value and transmit the measured ambient light value to the computing device 100 based on, for example, a triggering event, such as the detection that an occupant has exited the location of the device 130 or the environment 180 by other devices that monitor the environment 180, or based on an interval of time that has elapsed.

The ambient light value received at the computing device 100 from the device 130 may be input to a model solver 350. The model solver 350 may be any suitable combination of hardware and software on the computing device 100 for processing ambient light values using light source models, such as any of the light source models 143, 144, and 145, to determine if an artificial light source has been left on. The model solver 350 may select the appropriate one of the light source models 143, 144, and 145 of the device models 142 based on, for example, the time of day at which the ambient light value received from the device 130 was measured, compared to the time of day of the ambient light values used to train the light source models. For example, the ambient light value may have been measured at 7:35 am, which may result in the model solver 350 selecting the light source model 143, which may have been trained using the ambient light values 141 measured from 12:00 am to 8:00 am across each day of the training period. The model solver 350 may input the ambient light value to the light source model 143 to determine if any of the artificial light sources 121, 122, and 123 have been left on. The model solver 350 may use a likelihood-ratio test with the ambient light value and the light source model 143 to determine whether the ambient light value indicates that any of the artificial light sources 121, 122, and 123 have been left on. The model solver 350 may subject the likelihood-ratio determined using the likelihood-ratio test with the ambient light value and the light source model 143 to a threshold which may be used to generate a binary decision of whether the ambient light value indicates that any of the artificial light sources 121, 122, and 123 has been left on or whether the ambient light value only indicates light from the background light sources 111 and 112. If the likelihood-ratio is above a threshold value, this may indicate that some number of the artificial light sources 121, 122, and 123 have been left on. If the likelihood-ratio is not above the threshold value, this may indicate that none of the artificial light sources 121, 122, and 123 have been left on. For example, the likelihood-ratio generated by the model solver 350 using the ambient light value received from the device 130 and the light source model 143 may be above the threshold, indicating that one of the artificial light sources 121, 122, and 123 has been left on. In some implementations, the computing device 100 may use the lux level of the received ambient light value to determine that the artificial light source 122 has been left on while the artificial light sources 121 and 123 are off.

The computing device 100 may send a notification to a device 360. The device 360 may be any suitable computing device, such as, for example, a phone, tablet, laptop, desktop, or watch, or other stationary or wearable computing device. The device 360 may be associated with an occupant of the environment 180, or with any other suitable party. The recipient of the notification and contents of the notification may be dependent on the reason the ambient light value measured by the ambient light sensor 135 was sent to the computing device 100. For example, if the ambient light value was sent to the computing device 100 due to a triggering event of an occupant exiting the location of the device 130 or the environment 180, the device 360 that receives the notification may be a device associated with the occupant that was detected as exiting, such as a phone or wearable device, and the contents of the notification may indicate that the artificial light source 122 has been left on. If it was determined based on the likelihood-ration that no artificial light source was left on, no notification may be sent to the device 360. If the ambient light value was sent to the computing device 100 based on the elapsing of an interval of time, and the determination of whether an artificial light source has been left on indicates a change in the pattern of usage of artificial light sources, a notification may be sent to a device associated with the appropriate party for responding to, for example, an intruder or other unknown occupant in the environment 180 or an occupant who is ill or injured. The notification may be sent to the device 360 in any suitable manner, including, for example, through any suitable form of wireless communication, such as through a direct Wi-Fi connection, a Bluetooth connection, through a wireless local area network, or through the internet and cellular networks.

FIG. 3B shows an example system and arrangement suitable for light source status detection according to an implementation of the disclosed subject matter. In some implementations, the ambient light value measured by the ambient light sensor 135 may be transmitted to the cloud server system 190 through, for example, the internet 180. The model solver 350, on the computing device 100 in the cloud server system 190, may use the ambient light value received from the device 130 and the light source model 143 to determine whether any of the artificial light sources 121, 122, and 123 have been left on. The computing device 100 may send the notification to the device 360, for example, through internet 180, as appropriate based on whether an artificial light source has been left on and the reason the ambient light value was measure and sent to the computing device 100.

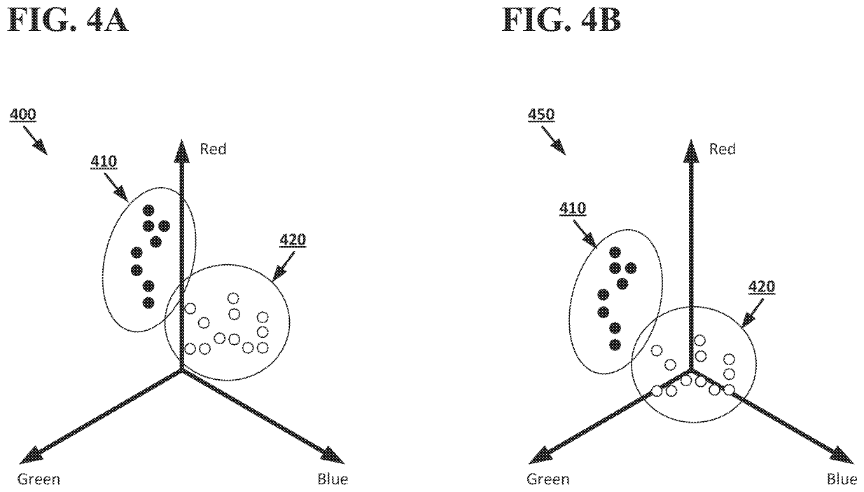

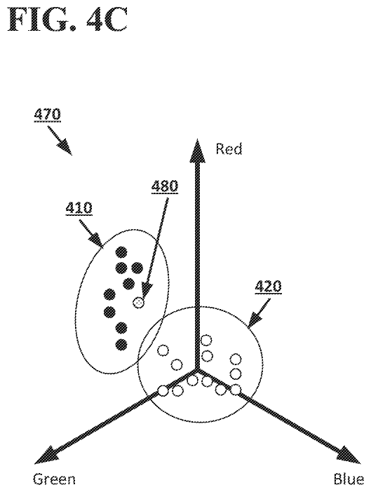

FIG. 4A shows an example visualization suitable for light source status detection according to an implementation of the disclosed subject matter. The model trainer 150 may fit a 2-cluster prior to the 2-gaussian model using the ambient light values 141 measured by the ambient light sensor 135 over the same time period across the different days of the training period in order to generate a light source model, such as the light source model 143. The graph 400 may visualize a clustering of the ambient light values from the same time period across the different days of the training period for the device 130 into an artificial light source cluster 410 and a background light source cluster 420, with each ambient light value being a tuple of red, green, and blue ambient light levels plotted on red, green, and blue axes of the graph 400.

FIG. 4B shows an example visualization suitable for light source status detection according to an implementation of the disclosed subject matter. After the 2-cluster prior has been fit to the 2-gaussian model by the model trainer 150, the mean of the background light source cluster 420 may be used to anchor-correct by centering background light source cluster 420 at the origin of the cluster model. The graph 450 may visualize the anchoring of the background light source cluster 420 to the origin of the light source model 143, and the movement of the artificial lights source cluster 410 to maintain the same relative positioning between the ambient light values of the background light source cluster 420 and the artificial light source cluster 410.

FIG. 4C shows an example visualization suitable for light source status detection according to an implementation of the disclosed subject matter. An ambient light value 480 measured by the ambient light sensor 135 may be used by the model solver 350 along with the light source model 143 to determine if the ambient light value indicates that an artificial light source has been left on. The graph 470 may visualize the determination of which of the artificial light source cluster 410 and the background light cluster 420 the ambient light value 480 belongs to according to the likelihood-ratio output by the light source model 143. The ambient light value 480 may, for example, belong with the artificial light source cluster 410, indicating that an artificial light source, such as the artificial light source 122, has been left on near the device 130.

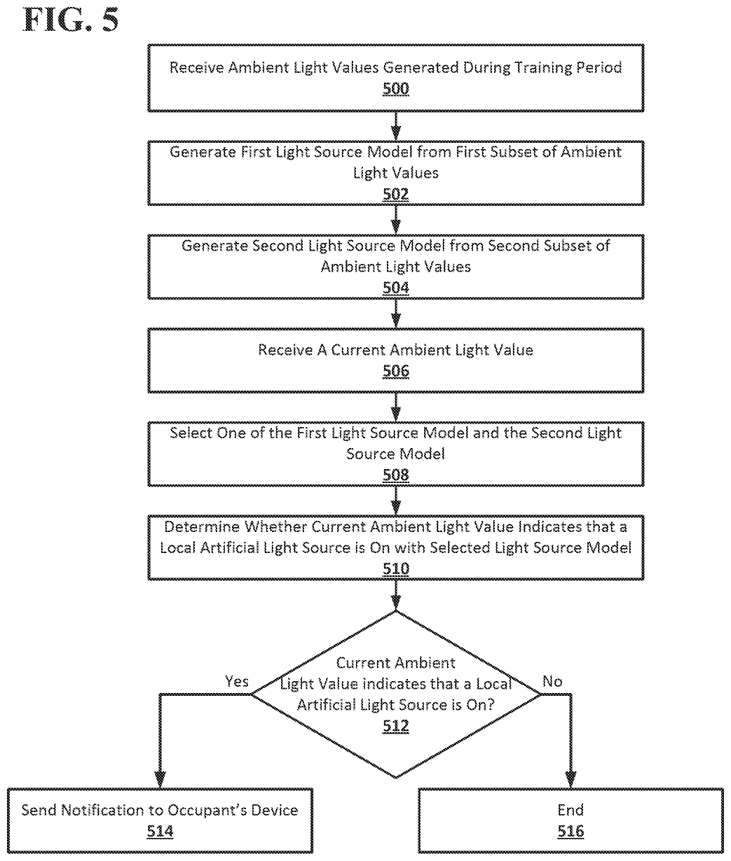

FIG. 5 shows an example of a process suitable for light source status detection according to an implementation of the disclosed subject matter.

At 500, ambient light values generated during a training period may be received.

At 502, a first light source model may be generated from a first subset of the ambient light values.

At 504, a second light source model may be generated from a second subset of the ambient light values.

At 506, a current ambient light value may be received.

At 508, one of the first light source model and the second light source model may be selected.

At 510, a whether the current ambient light value indicates that a local artificial light source is on may be determined with the selected light source model.

At 512, if the current ambient light value indicates that a local artificial light source is on, flow may proceed to 514. Otherwise flow may proceed to 516.

At 514, a notification may be sent to an occupant's device.

At 516, the flow may end with no action taken.

A computing device may receive ambient light values generated by an ambient light sensor of a device in an environment over a first period of time may be received from the device at a computing device. The computing device may generate a first light source model for the device using a first subset of the ambient light values. The computing device may generate a second light source model for the device using a second subset of the ambient light values. The computing device may receive from the device, a current ambient light value generated by the ambient light sensor of the device. The computing device may select one of either the first light source model or the second light source model based on a time at which the current ambient light value was generated by the ambient light sensor. The computing device may determine, using the current ambient light value and selected one of the first light source model and the second light source model, whether the current ambient light value indicates that a local artificial light source is on.

The computing device may generate a first light source model for the device using a first subset of the ambient light values comprising ambient light values by fitting a 2-gaussian model to the first subset of the ambient light values using a 2-cluster prior wherein the first subset of ambient light values is divided into a background light source cluster and a local artificial light source cluster by the fitting and centering the background light source cluster at the origin of the first light source model.

The computing device may fit a 2-gaussian model to the first subset of the ambient light values using a 2-cluster prior wherein the first subset of ambient light values is divided into a background light source cluster and a local artificial light source cluster by using Baum-Welch type optimization.

The computing device may determine, using the current ambient light value and selected one of the first light source model and the second light source model, whether the current ambient light value indicates that a local artificial light source is on by determining a likelihood-ratio based on the current ambient light value and the selected one of the first light source model and the second light source model and determining that a local artificial light source is on when the likelihood-ratio greater than a threshold value for the selected one of the first light source model and the second light source model or determining that a local artificial light source is not on when the likelihood-ratio is less than the threshold value for the selected one of the first light source model and the second light source model.

A notification may be sent to a device associated with an occupant when the current ambient light value indicates that a local artificial light source is on.

The current ambient light value generated by the ambient light sensor of the device may be received at the computing device after a determination by any computing device in or associated with the environment that an occupant of the environment has exited the environment. The determination that the occupant of the environment has exited the environment may be a triggering event for generating and sending the current ambient light value to the computing device.

The first subset of the ambient light values may include ambient light values generated over a same second time period on each day of the first time period. The second subset of the ambient light values may include ambient light values generated over a same third time period on each day of the first time period. The first subset of the ambient light values and the second subset of the ambient light values are disjoint.

The computing device may select one of either the first light source model or the second light source model based on a time at which the current ambient light value was generated by the ambient light sensor by comparing the time of day at which the current ambient light value was generated to the times of day at which the ambient light values in the first subset of ambient light values were generated and the times of day at which the ambient light values in the second subset of ambient light values were generated.

The first time period comprises a training period for light source models for the device at a current location of the device in the environment.

A system may include a computing device that receives, from a device in an environment, ambient light values generated by an ambient light sensor of the device over a first period of time, generates a first light source model for the device using a first subset of the ambient light values, generates a second light source model for the device using a second subset of the ambient light values, receives from the device a current ambient light value generated by the ambient light sensor of the device, selects one of either the first light source model or the second light source model based on a time at which the current ambient light value was generated by the ambient light sensor, and determines using the current ambient light value and selected one of the first light source model and the second light source model, whether the current ambient light value indicates that a local artificial light source is on.

The computing device of the system may generate a first light source model for the device using a first subset of the ambient light values comprising ambient light values by fitting a 2-gaussian model to the first subset of the ambient light values using a 2-cluster prior wherein the first subset of ambient light values is divided into a background light source cluster and a local artificial light source cluster by the fitting, and centering the background light source cluster at the origin of the first light source model.

The computing device of the system may fit a 2-gaussian model to the first subset of the ambient light values using a 2-cluster prior wherein the first subset of ambient light values is divided into a background light source cluster and a local artificial light source cluster further comprises using Baum-Welch type optimization.

The computing device of the system may determine, using the current ambient light value and selected one of the first light source model and the second light source model, whether the current ambient light value indicates that a local artificial light source is on and light from the local artificial light source is detected by the ambient light sensor of the device further by determining a likelihood-ratio based on the current ambient light value and the selected one of the first light source model and the second light source model, and determining that a local artificial light source is on when the likelihood-ratio greater than a threshold value for the selected one of the first light source model and the second light source model or determining that a local artificial light source is not on when the likelihood-ratio is less than the threshold value for the selected one of the first light source model and the second light source model.

The computing device of the system may a notification to a device associated with an occupant when the current ambient light value indicates that a local artificial light source is on.

The computing device of the system may receive the current ambient light value generated by the ambient light sensor of the device after a determination by any computing device in or associated with the environment that an occupant of the environment has exited the environment, where the determination that the occupant of the environment has exited the environment is a triggering event for generating and sending the current ambient light value to the computing device.

The computing device may select one of either the first light source model or the second light source model based on a time at which the current ambient light value was generated by the ambient light sensor by comparing the time of day at which the current ambient light value was generated to the times of day at which the ambient light values in the first subset of ambient light values were generated and the times of day at which the ambient light values in the second subset of ambient light values were generated.

According to an embodiment of the disclosed subject matter, a means for receiving, on a computing device from a device in an environment, ambient light values generated by an ambient light sensor of the device over a first period of time, a means for generating, by the computing device, a first light source model for the device using a first subset of the ambient light values, a means for generating, by the computing device, a second light source model for the device using a second subset of the ambient light values, a means for receiving, on the computing device from the device, a current ambient light value generated by the ambient light sensor of the device, a means for selecting, by the computing device, one of either the first light source model or the second light source model based on a time at which the current ambient light value was generated by the ambient light sensor, a means for determining, by the computing device, using the current ambient light value and selected one of the first light source model and the second light source model, whether the current ambient light value indicates that a local artificial light source is on, a means for fitting a 2-gaussian model to the first subset of the ambient light values using a 2-cluster prior wherein the first subset of ambient light values is divided into a background light source cluster and a local artificial light source cluster by the fitting, a means for centering the background light source cluster at the origin of the first light source model, a means for determining a likelihood-ratio based on the current ambient light value and the selected one of the first light source model and the second light source model, a means for determining that a local artificial light source is on when the likelihood-ratio greater than a threshold value for the selected one of the first light source model and the second light source model, a means for determining that a local artificial light source is not on when the likelihood-ratio is less than the threshold value for the selected one of the first light source model and the second light source model, a means for sending a notification to a device associated with an occupant when the current ambient light value indicates that a local artificial light source is on, and a means for comparing the time of day at which the current ambient light value was generated to the times of day at which the ambient light values in the first subset of ambient light values were generated and the times of day at which the ambient light values in the second subset of ambient light values were generated, are included.

Embodiments disclosed herein may use one or more sensors. In general, a “sensor” may refer to any device that can obtain information about its environment. Sensors may be described by the type of information they collect. For example, sensor types as disclosed herein may include motion, smoke, carbon monoxide, proximity, temperature, time, physical orientation, acceleration, location, and the like. A sensor also may be described in terms of the particular physical device that obtains the environmental information. For example, an accelerometer may obtain acceleration information, and thus may be used as a general motion sensor and/or an acceleration sensor. A sensor also may be described in terms of the specific hardware components used to implement the sensor. For example, a temperature sensor may include a thermistor, thermocouple, resistance temperature detector, integrated circuit temperature detector, or combinations thereof. In some cases, a sensor may operate as multiple sensor types sequentially or concurrently, such as where a temperature sensor is used to detect a change in temperature, as well as the presence of a person or animal.

In general, a “sensor” as disclosed herein may include multiple sensors or sub-sensors, such as where a position sensor includes both a global positioning sensor (GPS) as well as a wireless network sensor, which provides data that can be correlated with known wireless networks to obtain location information. Multiple sensors may be arranged in a single physical housing, such as where a single device includes movement, temperature, magnetic, and/or other sensors. Such a housing also may be referred to as a sensor or a sensor device. For clarity, sensors are described with respect to the particular functions they perform and/or the particular physical hardware used, when such specification is necessary for understanding of the embodiments disclosed herein.

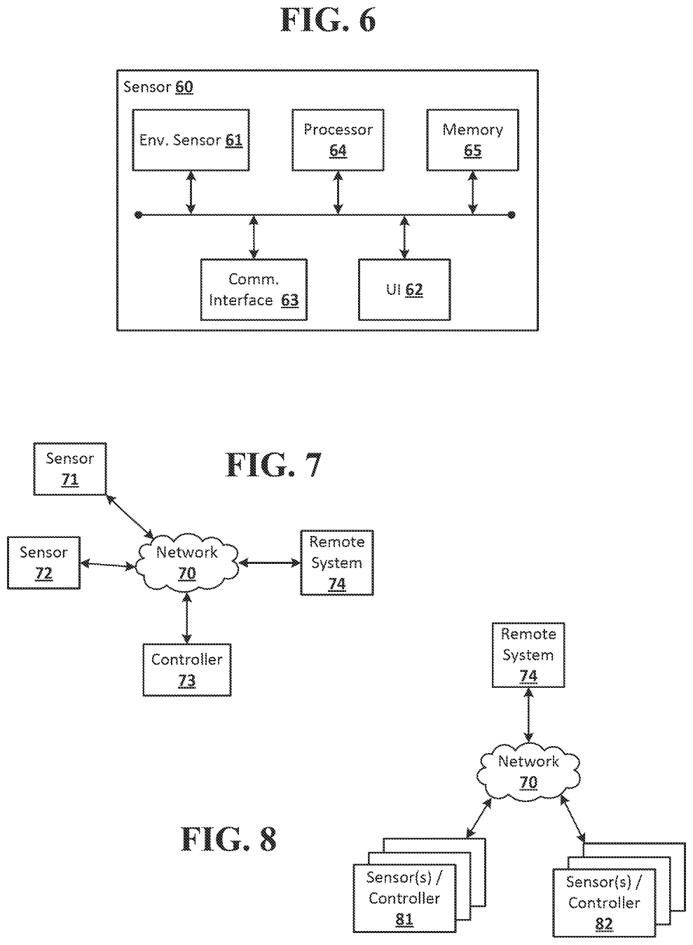

A sensor may include hardware in addition to the specific physical sensor that obtains information about the environment. FIG. 6 shows an example sensor as disclosed herein. The sensor 60 may include an environmental sensor 61, such as a temperature sensor, smoke sensor, carbon monoxide sensor, motion sensor, accelerometer, proximity sensor, passive infrared (PIR) sensor, magnetic field sensor, radio frequency (RF) sensor, light sensor, humidity sensor, or any other suitable environmental sensor, that obtains a corresponding type of information about the environment in which the sensor 60 is located. A processor 64 may receive and analyze data obtained by the sensor 61, control operation of other components of the sensor 60, and process communication between the sensor and other devices. The processor 64 may execute instructions stored on a computer-readable memory 65. The memory 65 or another memory in the sensor 60 may also store environmental data obtained by the sensor 61. A communication interface 63, such as a Wi-Fi or other wireless interface, Ethernet or other local network interface, or the like may allow for communication by the sensor 60 with other devices. A user interface (UI) 62 may provide information and/or receive input from a user of the sensor. The UI 62 may include, for example, a speaker to output an audible alarm when an event is detected by the sensor 60. Alternatively, or in addition, the UI 62 may include a light to be activated when an event is detected by the sensor 60. The user interface may be relatively minimal, such as a limited-output display, or it may be a full-featured interface such as a touchscreen. Components within the sensor 60 may transmit and receive information to and from one another via an internal bus or other mechanism as will be readily understood by one of skill in the art. One or more components may be implemented in a single physical arrangement, such as where multiple components are implemented on a single integrated circuit. Sensors as disclosed herein may include other components, and/or may not include all of the illustrative components shown.

Sensors as disclosed herein may operate within a communication network, such as a conventional wireless network, and/or a sensor-specific network through which sensors may communicate with one another and/or with dedicated other devices. In some configurations one or more sensors may provide information to one or more other sensors, to a central controller, or to any other device capable of communicating on a network with the one or more sensors. A central controller may be general- or special-purpose. For example, one type of central controller is a home automation network, that collects and analyzes data from one or more sensors within the home. Another example of a central controller is a special-purpose controller that is dedicated to a subset of functions, such as a security controller that collects and analyzes sensor data primarily or exclusively as it relates to various security considerations for a location. A central controller may be located locally with respect to the sensors with which it communicates and from which it obtains sensor data, such as in the case where it is positioned within a home that includes a home automation and/or sensor network. Alternatively or in addition, a central controller as disclosed herein may be remote from the sensors, such as where the central controller is implemented as a cloud-based system that communicates with multiple sensors, which may be located at multiple locations and may be local or remote with respect to one another.

FIG. 7 shows an example of a sensor network as disclosed herein, which may be implemented over any suitable wired and/or wireless communication networks. One or more sensors 71, 72 may communicate via a local network 70, such as a Wi-Fi or other suitable network, with each other and/or with a controller 73. The controller may be a general- or special-purpose computer. The controller may, for example, receive, aggregate, and/or analyze environmental information received from the sensors 71, 72. The sensors 71, 72 and the controller 73 may be located locally to one another, such as within a single dwelling, office space, building, room, or the like, or they may be remote from each other, such as where the controller 73 is implemented in a remote system 74 such as a cloud-based reporting and/or analysis system. Alternatively or in addition, sensors may communicate directly with a remote system 74. The remote system 74 may, for example, aggregate data from multiple locations, provide instruction, software updates, and/or aggregated data to a controller 73 and/or sensors 71, 72.

For example, the hub computing device 155 may be an example of a controller 73 and the sensors 210 may be examples of sensors 71 and 72, as shown and described in further detail with respect to FIGS. 1-10.

The devices of the security system and home environment of the disclosed subject matter may be communicatively connected via the network 70, which may be a mesh-type network such as Thread, which provides network architecture and/or protocols for devices to communicate with one another. Typical home networks may have a single device point of communications. Such networks may be prone to failure, such that devices of the network cannot communicate with one another when the single device point does not operate normally. The mesh-type network of Thread, which may be used in the security system of the disclosed subject matter, may avoid communication using a single device. That is, in the mesh-type network, such as network 70, there is no single point of communication that may fail so as to prohibit devices coupled to the network from communicating with one another.

The communication and network protocols used by the devices communicatively coupled to the network 70 may provide secure communications, minimize the amount of power used (i.e., be power efficient), and support a wide variety of devices and/or products in a home, such as appliances, access control, climate control, energy management, lighting, safety, and security. For example, the protocols supported by the network and the devices connected thereto may have an open protocol which may carry IPv6 natively.

The Thread network, such as network 70, may be easy to set up and secure to use. The network 70 may use an authentication scheme, AES (Advanced Encryption Standard) encryption, or the like to reduce and/or minimize security holes that exist in other wireless protocols. The Thread network may be scalable to connect devices (e.g., 2, 5, 10, 20, 50, 100, 150, 200, or more devices) into a single network supporting multiple hops (e.g., so as to provide communications between devices when one or more nodes of the network is not operating normally). The network 70, which may be a Thread network, may provide security at the network and application layers. One or more devices communicatively coupled to the network 70 (e.g., controller 73, remote system 74, and the like) may store product install codes to ensure only authorized devices can join the network 70. One or more operations and communications of network 70 may use cryptography, such as public-key cryptography.

The devices communicatively coupled to the network 70 of the home environment and/or security system disclosed herein may low power consumption and/or reduced power consumption. That is, devices efficiently communicate to with one another and operate to provide functionality to the user, where the devices may have reduced battery size and increased battery lifetimes over conventional devices. The devices may include sleep modes to increase battery life and reduce power requirements. For example, communications between devices coupled to the network 70 may use the power-efficient IEEE 802.15.4 MAC/PHY protocol. In embodiments of the disclosed subject matter, short messaging between devices on the network 70 may conserve bandwidth and power. The routing protocol of the network 70 may reduce network overhead and latency. The communication interfaces of the devices coupled to the home environment may include wireless system-on-chips to support the low-power, secure, stable, and/or scalable communications network 70.

The sensor network shown in FIG. 7 may be an example of a home environment. The depicted home environment may include a structure, a house, office building, garage, mobile home, or the like. The devices of the environment, such as the sensors 71, 72, the controller 73, and the network 70 may be integrated into a home environment that does not include an entire structure, such as an apartment, condominium, or office space.

The environment can control and/or be coupled to devices outside of the structure. For example, one or more of the sensors 71, 72 may be located outside the structure, for example, at one or more distances from the structure (e.g., sensors 71, 72 may be disposed outside the structure, at points along a land perimeter on which the structure is located, and the like. One or more of the devices in the environment need not physically be within the structure. For example, the controller 73 which may receive input from the sensors 71, 72 may be located outside of the structure.

The structure of the home environment may include a plurality of rooms, separated at least partly from each other via walls. The walls can include interior walls or exterior walls. Each room can further include a floor and a ceiling. Devices of the home environment, such as the sensors 71, 72, may be mounted on, integrated with and/or supported by a wall, floor, or ceiling of the structure.

The home environment including the sensor network shown in FIG. 7 may include a plurality of devices, including intelligent, multi-sensing, network-connected devices that can integrate seamlessly with each other and/or with a central server or a cloud-computing system (e.g., controller 73 and/or remote system 74) to provide home-security and home features. The home environment may include one or more intelligent, multi-sensing, network-connected thermostats one or more intelligent, network-connected, multi-sensing hazard detection units and one or more intelligent, multi-sensing, network-connected entryway interface devices. The hazard detectors, thermostats, and doorbells may be the sensors 71, 72 shown in FIG. 7.

According to embodiments of the disclosed subject matter, the thermostat may detect ambient climate characteristics (e.g., temperature and/or humidity) and may control an HVAC (heating, ventilating, and air conditioning) system accordingly of the structure. For example, the ambient client characteristics may be detected by sensors 71, 72 shown in FIG. 7, and the controller 73 may control the HVAC system (not shown) of the structure.

A hazard detector may detect the presence of a hazardous substance or a substance indicative of a hazardous substance (e.g., smoke, fire, or carbon monoxide). For example, smoke, fire, and/or carbon monoxide may be detected by sensors 71, 72 shown in FIG. 7, and the controller 73 may control an alarm system to provide a visual and/or audible alarm to the user of the home environment.

A doorbell may control doorbell functionality, detect a person's approach to or departure from a location (e.g., an outer door to the structure), and announce a person's approach or departure from the structure via audible and/or visual message that is output by a speaker and/or a display coupled to, for example, the controller 73.

In some embodiments, the home environment of the sensor network shown in FIG. 7 may include one or more intelligent, multi-sensing, network-connected wall switches, one or more intelligent, multi-sensing, network-connected wall plug. The wall switches and/or wall plugs may be the sensors 71, 72 shown in FIG. 7. The wall switches may detect ambient lighting conditions, and control a power and/or dim state of one or more lights. For example, the sensors 71, 72, may detect the ambient lighting conditions, and the controller 73 may control the power to one or more lights (not shown) in the home environment. The wall switches may also control a power state or speed of a fan, such as a ceiling fan. For example, sensors 72, 72 may detect the power and/or speed of a fan, and the controller 73 may adjusting the power and/or speed of the fan, accordingly. The wall plugs may control supply of power to one or more wall plugs (e.g., such that power is not supplied to the plug if nobody is detected to be within the home environment). For example, one of the wall plugs may controls supply of power to a lamp (not shown).

In embodiments of the disclosed subject matter, the home environment may include one or more intelligent, multi-sensing, network-connected entry detectors. The sensors 71, 72 shown in FIG. 7 may be the entry detectors. The illustrated entry detectors (e.g., sensors 71, 72) may be disposed at one or more windows, doors, and other entry points of the home environment for detecting when a window, door, or other entry point is opened, broken, breached, and/or compromised. The entry detectors may generate a corresponding signal to be provided to the controller 73 and/or the remote system 74 when a window or door is opened, closed, breached, and/or compromised. In some embodiments of the disclosed subject matter, the alarm system, which may be included with controller 73 and/or coupled to the network 70 may not arm unless all entry detectors (e.g., sensors 71, 72) indicate that all doors, windows, entryways, and the like are closed and/or that all entry detectors are armed.

The home environment of the sensor network shown in FIG. 7 can include one or more intelligent, multi-sensing, network-connected doorknobs. For example, the sensors 71, 72 may be coupled to a doorknob of a door (e.g., doorknobs 122 located on external doors of the structure of the home environment). However, it should be appreciated that doorknobs can be provided on external and/or internal doors of the home environment.

The thermostats, the hazard detectors, the doorbells, the wall switches, the wall plugs, the entry detectors, the doorknobs, the keypads, and other devices of the home environment (e.g., as illustrated as sensors 71, 72 of FIG. 7 can be communicatively coupled to each other via the network 70, and to the controller 73 and/or remote system 74 to provide security, safety, and/or comfort for the environment).

A user can interact with one or more of the network-connected devices (e.g., via the network 70). For example, a user can communicate with one or more of the network-connected devices using a computer (e.g., a desktop computer, laptop computer, tablet, or the like) or other portable electronic device (e.g., a phone, a tablet, a key FOB, and the like). A webpage or application can be configured to receive communications from the user and control the one or more of the network-connected devices based on the communications and/or to present information about the device's operation to the user. For example, the user can view can arm or disarm the security system of the home.

One or more users can control one or more of the network-connected devices in the home environment using a network-connected computer or portable electronic device. In some examples, some or all of the users (e.g., individuals who live in the home) can register their mobile device and/or key FOBs with the home environment (e.g., with the controller 73). Such registration can be made at a central server (e.g., the controller 73 and/or the remote system 74) to authenticate the user and/or the electronic device as being associated with the home environment, and to provide permission to the user to use the electronic device to control the network-connected devices and the security system of the home environment. A user can use their registered electronic device to remotely control the network-connected devices and security system of the home environment, such as when the occupant is at work or on vacation. The user may also use their registered electronic device to control the network-connected devices when the user is located inside the home environment.

Alternatively, or in addition to registering electronic devices, the home environment may make inferences about which individuals live in the home and are therefore users and which electronic devices are associated with those individuals. As such, the home environment “learns” who is a user (e.g., an authorized user) and permits the electronic devices associated with those individuals to control the network-connected devices of the home environment (e.g., devices communicatively coupled to the network 70). Various types of notices and other information may be provided to users via messages sent to one or more user electronic devices. For example, the messages can be sent via email, short message service (SMS), multimedia messaging service (MMS), unstructured supplementary service data (USSD), as well as any other type of messaging services and/or communication protocols.

The home environment may include communication with devices outside of the home environment but within a proximate geographical range of the home. For example, the home environment may include an outdoor lighting system (not shown) that communicates information through the communication network 70 or directly to a central server or cloud-computing system (e.g., controller 73 and/or remote system 74) regarding detected movement and/or presence of people, animals, and any other objects and receives back commands for controlling the lighting accordingly.

The controller 73 and/or remote system 74 can control the outdoor lighting system based on information received from the other network-connected devices in the home environment. For example, in the event, any of the network-connected devices, such as wall plugs located outdoors, detect movement at night time, the controller 73 and/or remote system 74 can activate the outdoor lighting system and/or other lights in the home environment.

In some configurations, a remote system 74 may aggregate data from multiple locations, such as multiple buildings, multi-resident buildings, individual residences within a neighborhood, multiple neighborhoods, and the like. In general, multiple sensor/controller systems 81, 82 as previously described with respect to FIG. 10 may provide information to the remote system 74. The systems 81, 82 may provide data directly from one or more sensors as previously described, or the data may be aggregated and/or analyzed by local controllers such as the controller 73, which then communicates with the remote system 74. The remote system may aggregate and analyze the data from multiple locations, and may provide aggregate results to each location. For example, the remote system 74 may examine larger regions for common sensor data or trends in sensor data, and provide information on the identified commonality or environmental data trends to each local system 81, 82.

In situations in which the systems discussed here collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. Thus, the user may have control over how information is collected about the user and used by a system as disclosed herein.

Embodiments of the presently disclosed subject matter may be implemented in and used with a variety of computing devices. FIG. 9 is an example computing device 20 suitable for implementing embodiments of the presently disclosed subject matter. For example, the device 20 may be used to implement a controller, a device including sensors as disclosed herein, or the like. Alternatively or in addition, the device 20 may be, for example, a desktop or laptop computer, or a mobile computing device such as a phone, tablet, or the like. The device 20 may include a bus 21 which interconnects major components of the computer 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection.

The bus 21 allows data communication between the central processor 24 and one or more memory components 25, 27, which may include RAM, ROM, and other memory, as previously noted. Applications resident with the computer 20 are generally stored on and accessed via a computer readable storage medium.

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the device to communicate with other computers via one or more local, wide-area, or other communication networks, as described in further detail herein.

FIG. 8 shows an example network arrangement according to an embodiment of the disclosed subject matter. One or more clients 10, 11, such as local computers, phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. One or more processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as hard drives, USB (universal serial bus) drives, or any other machine readable storage medium, such that when the computer program code is loaded into and executed by a computer, the computer becomes an apparatus for practicing embodiments of the disclosed subject matter. When implemented on a general-purpose microprocessor, the computer program code may configure the microprocessor to become a special-purpose device, such as by creation of specific logic circuits as specified by the instructions.

Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed by a data processing apparatus, the method comprising:
receiving, on a computing device from a device in an environment, ambient light values generated by an ambient light sensor of the device over a first period of time;
generating, by the computing device, a first light source model for the device using a first subset of the ambient light values;
generating, by the computing device, a second light source model for the device using a second subset of the ambient light values;
receiving, on the computing device from the device, a current ambient light value generated by the ambient light sensor of the device;
selecting, by the computing device, one of either the first light source model or the second light source model based on a time at which the current ambient light value was generated by the ambient light sensor; and
determining, by the computing device, using the current ambient light value and selected one of the first light source model and the second light source model, whether the current ambient light value indicates that a local artificial light source is on.

2. The method of claim 1, wherein generating, by the computing device, a first light source model for the device using a first subset of the ambient light values comprising ambient light values comprises:
fitting a 2-gaussian model to the first subset of the ambient light values using a 2-cluster prior wherein the first subset of ambient light values is divided into a background light source cluster and a local artificial light source cluster by the fitting; and
centering the background light source cluster at the origin of the first light source model.

3. The method of claim 2, wherein fitting a 2-gaussian model to the first subset of the ambient light values using a 2-cluster prior wherein the first subset of ambient light values is divided into a background light source cluster and a local artificial light source cluster further comprises using Baum-Welch type optimization.

4. The method of claim 1, wherein determining, using the current ambient light value and selected one of the first light source model and the second light source model, whether the current ambient light value indicates that a local artificial light source is on further comprises:
determining a likelihood-ratio based on the current ambient light value and the selected one of the first light source model and the second light source model; and
determining that a local artificial light source is on when the likelihood-ratio greater than a threshold value for the selected one of the first light source model and the second light source model or determining that a local artificial light source is not on when the likelihood-ratio is less than the threshold value for the selected one of the first light source model and the second light source model.

5. The method of claim 1, further comprising sending a notification to a device associated with an occupant when the current ambient light value indicates that a local artificial light source is on.

6. The method of claim 1, wherein the current ambient light value generated by the ambient light sensor of the device is received at the computing device after a determination by any computing device in or associated with the environment that an occupant of the environment has exited the environment, and wherein the determination that the occupant of the environment has exited the environment is a triggering event for generating and sending the current ambient light value to the computing device.

7. The method of claim 1, wherein the first subset of the ambient light values comprises ambient light values generated over a same second time period on each day of the first time period, the second subset of the ambient light values comprises ambient light values generated over a same third time period on each day of the first time period, and the first subset of the ambient light values and the second subset of the ambient light values are disjoint.

8. The method of claim 1, wherein selecting, by the computing device, one of either the first light source model or the second light source model based on a time at which the current ambient light value was generated by the ambient light sensor comprises comparing the time of day at which the current ambient light value was generated to the times of day at which the ambient light values in the first subset of ambient light values were generated and the times of day at which the ambient light values in the second subset of ambient light values were generated.

9. The method of claim 1, wherein the first time period comprises a training period for light source models for the device at a current location of the device in the environment.

10. A computer-implemented system for light source status detection comprising:
a computing device that receives, from a device in an environment, ambient light values generated by an ambient light sensor of the device over a first period of time,
generates a first light source model for the device using a first subset of the ambient light values,
generates a second light source model for the device using a second subset of the ambient light values,
receives from the device a current ambient light value generated by the ambient light sensor of the device,
selects one of either the first light source model or the second light source model based on a time at which the current ambient light value was generated by the ambient light sensor, and
determines using the current ambient light value and selected one of the first light source model and the second light source model, whether the current ambient light value indicates that a local artificial light source is on.

11. The computer-implemented system of claim 10, wherein computing device generates a first light source model for the device using a first subset of the ambient light values comprising ambient light values by:
fitting a 2-gaussian model to the first subset of the ambient light values using a 2-cluster prior wherein the first subset of ambient light values is divided into a background light source cluster and a local artificial light source cluster by the fitting, and
centering the background light source cluster at the origin of the first light source model.

12. The computer-implemented system of claim 11, wherein the computing device fits a 2-gaussian model to the first subset of the ambient light values using a 2-cluster prior wherein the first subset of ambient light values is divided into a background light source cluster and a local artificial light source cluster further comprises using Baum-Welch type optimization.

13. The computer-implemented system of claim 10, wherein the computing device determines, using the current ambient light value and selected one of the first light source model and the second light source model, whether the current ambient light value indicates that a local artificial light source is on by:
determining a likelihood-ratio based on the current ambient light value and the selected one of the first light source model and the second light source model, and
determining that a local artificial light source is on when the likelihood-ratio greater than a threshold value for the selected one of the first light source model and the second light source model or determining that a local artificial light source is not on when the likelihood-ratio is less than the threshold value for the selected one of the first light source model and the second light source model.

14. The computer-implemented system of claim 10, wherein the computing device further sends a notification to a device associated with an occupant when the current ambient light value indicates that a local artificial light source is on.

15. The computer-implemented system of claim 10, wherein the current ambient light value generated by the ambient light sensor of the device is received at the computing device after a determination by any computing device in or associated with the environment that an occupant of the environment has exited the environment, and wherein the determination that the occupant of the environment has exited the environment is a triggering event for generating and sending the current ambient light value to the computing device.

16. The computer-implemented system of claim 10, wherein the first subset of the ambient light values comprises ambient light values generated over a same second time period on each day of the first time period, the second subset of the ambient light values comprises ambient light values generated over a same third time period on each day of the first time period, and the first subset of the ambient light values and the second subset of the ambient light values are disjoint.

17. The computer-implemented system of claim 16, wherein the computing device selects one of either the first light source model or the second light source model based on a time at which the current ambient light value was generated by the ambient light sensor by comparing the time of day at which the current ambient light value was generated to the times of day at which the ambient light values in the first subset of ambient light values were generated and the times of day at which the ambient light values in the second subset of ambient light values were generated.

18. The computer-implemented system of claim 10, wherein the first time period comprises a training period for light source models for the device at a current location of the device in the environment.

19. A system comprising: one or more computers and one or more storage devices storing instructions which are operable, when executed by the one or more computers, to cause the one or more computers to perform operations comprising:
receiving, from a device in an environment, ambient light values generated by an ambient light sensor of the device over a first period of time;
generating a first light source model for the device using a first subset of the ambient light values;
generating a second light source model for the device using a second subset of the ambient light values;
receiving, from the device, a current ambient light value generated by the ambient light sensor of the device;
selecting one of either the first light source model or the second light source model based on a time at which the current ambient light value was generated by the ambient light sensor; and
determining using the current ambient light value and selected one of the first light source model and the second light source model, whether the current ambient light value indicates that a local artificial light source is on.

20. The system of claim 19, wherein the instructions further cause the one or more computers to perform operations comprising sending a notification to a device associated with an occupant when the current ambient light value indicates that a local artificial light source is on.
